(19) United States
(12) Patent Application Publication
(10) Pub. No.: US 2021/0342781 A1
(43) Pub. Date: Nov. 4, 2021

(54) SYSTEM AND METHOD OF CREATING AN ADDRESSEE IDENTIFIER, FOR MAIL & OTHER PURPOSES

(71) Applicant: Harish Venkat, San Jose, CA (US)

(72) Inventor: Harish Venkat, San Jose, CA (US)

(21) Appl. No.: 17/379,100

(22) Filed: Jul. 19, 2021

Related U.S. Application Data
(60) Provisional application No. 63/138,055, filed on Jan. 15, 2021.

(51) Int. Cl. G06Q 10/08; G06K 7/14; G06K 7/10; G06K 19/06; G06F 16/245; H04L 29/06

(52) U.S. Cl. CPC G06Q 10/0838; G06K 7/1413; G06K 7/10861; G06K 2007/10504; G06F 16/245; H04L 63/0876; G06K 19/06028

(57) ABSTRACT

A system and method to create a permanent identifier for an individual that uniquely identifies the individual. While a mailing address of the individual changes during the individual's lifetime, the unique identifier does not. This allows the individual to use the identifier as the address conduit to get mail delivered to the individual wherever the individual resides. The system can receive a request from an individual to generate a one-time life-long unique identifier, using the individual's unique information. The system can also receive a current mailing address that can be associated with the unique identifier. If an old address was tagged to that identifier, the current address will override & replace the old address tagged to the identifier. Once the mailing address is associated with the unique identifier, the individual can use the unique identifier as the mailing ‘address’ instead of the actual street address. The unique identifier can be mentioned in correspondences or parcels as the ‘address’ instead of the mailing address, and the courier company can retrieve the current mailing address associated with the unique identifier. This system & method makes an individual's mailing address consistent, permanent, and unique to the individual.

### CROSS-REFERENCE TO RELATED APPLICATIONS

This application claims priority from the U.S. provisional patent application Ser. No. 63/138,055, filed on Jan. 15, 2021, which is incorporated herein by reference in its entirety.

### FIELD OF INVENTION

The present invention relates to a system and method for managing postal addressees & their address changes, and more particularly, the present invention relates to a system and method for creating a unique addressee identifier, addressing mails only with the unique identifier, and identifying the address tagged to the unique identifier.

### BACKGROUND

For correspondences and like communications, a mailing address is generally provided. For example, service providers send their invoices and bills to the registered mailing address of a person. Similarly, friends and relatives can send correspondences and parcels to the mailing addresses through courier services. Additionally, eCommerce companies send products directly to consumer addresses through courier services.

It is common for people to move to a new address. It has been estimated that one in seven individuals in the United States change their address every year. Approximately, 40 million Americans move every year. Similarly, businesses change their addresses often. Updating the address with postal services, companies, friends, and relatives can be a time-consuming and troublesome process. In case the address is not updated, the correspondences continue to be delivered to the old address. Thus, an individual may lose correspondence if the individual fails to update the address, resulting in a huge pile of undeliverable mail.

Also, a long and unsolved desire is there for a system and method that avoids the time-consuming need to inform a change-of-address to everyone one interacts with. Also, a long and unsolved desire is there to not leave behind an old and stale address of oneself with others.

Thus, there is a long & unsolved desire is there for a system that overcomes the aforesaid problems.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method that provides for generating a unique identifier for an individual other than a social security number.

Another object of the present invention is directed to a system and method for linking a current mailing address of an individual to the unique identifier.

In another object, the system and method can utilize an existing postal address bar-code identifier that uniquely identifies every mailing address.

In one aspect, the system and method allow mail to be delivered based on the unique identifier identifier and avoids the need to have mail addressed to the mailing address.

In one aspect, a postal mail addressed to the unique identifier, will indeed be delivered to the mailing address that the unique identifier is linked to.

In one aspect, disclosed is a system and method that issues a unique identifier to an individual. The system can receive a request from an individual to generate & issue a unique identifier. The system issues the unique identifier by using the combination of the last four digits of a social security number, year of birth and the last name of the individual to generate the unique identifier. Once the identifier is issued, it is valid for lifelong. The individual can use this lifelong identifier as a conduit to the mailing address.

In one aspect, disclosed is a system and method for managing a mailing address of an individual. The system can receive a current mailing address that can be associated with the unique identifier. Once the mailing address is associated with the unique identifier, the individual can use the unique identifier as his mailing/postal address instead of the actual address. The unique identifier that is unique for each individual, can be mentioned on correspondences or parcels as the delivery address, and the courier company can retrieve the current mailing address associated with the unique identifier. Thus, a sender of mail, rather than writing the address of the addressee, can now simply write the unique identifier associated with the addressee.

In one aspect, the unique identifier can be an alphanumeric number having a predetermined number of characters.

In one aspect, the mailing address can be updated, wherein the system can receive the request for changing the current mailing address. Upon receiving the request, the system can replace the current mailing address associated with the unique identifier with the new mailing address provided by the individual.

In one aspect, the disclosed system can verify the identity of the individual that requests for generating the new unique identifier or updating the current mailing address.

In one aspect, the system can receive a request from a courier company, wherein the request includes the unique identifier. The disclosed system can retrieve the current mailing address associated with the unique identifier and transmits the same to the courier company.

In one aspect, the system can also associate location coordinates of the current mailing address with the unique identifier. The location coordinates can be used with navigation software for navigating to the current mailing address.

In one aspect, the unique identifier can be represented in the form of a barcode, QR code, and like.

These and other objects and advantages of the embodiments herein and the summary will become readily apparent from the following detailed description taken in conjunction with the accompanying drawings.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is an environmental diagram showing the disclosed system, an individual device, and a service provider device, according to an exemplary embodiment of the present invention.

FIG. 2 is a flowchart showing the steps for generating a new unique identifier for the individual, according to an exemplary embodiment of the present invention.

FIG. 3 is a flowchart showing the steps for updating a mailing address, according to an exemplary embodiment of the present invention.

FIG. 4 is a flow chart showing steps in the delivery of a parcel by a service provider, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a system and method for generating a unique identifier for individuals different from known unique identifiers such as social security numbers, as the disclosed unique identifier can be unique for each individual and mails can be send to the individual using the unique identifier. The disclosed unique identifier can be a virtual permanent mailing address for an individual. During the life time of the individual the unique identifier remains the same and so the virtual permanent mailing address, while the real mailing address can change from time to time. The unique identifier can be shared with companies, service provides, friends and relatives, wherein correspondences and parcels can be addressed only with the unique identifier without mentioning the mailing address. The courier companies can retrieve the current mailing address associated with the new unique identifier from the disclosed system.

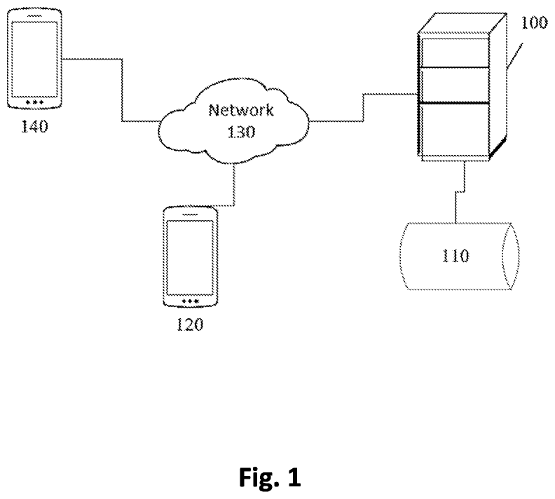

Referring to FIG. 1 which is a block diagram showing the disclosed system 100 connected to an individual device 120 and a service provider device 140 through a network 130. The network 130 can be a wired or wireless network. System 100 can also connect to a database 110. The system 100 can receive a request from the individual device 120 for a new unique identifier generation or updating a current mailing address. In one case, the unique identifier can be generated by the system 100. The disclosed system 100 can receive additional details of the individual, such as complete name, current mailing address, contact number, verification document, and like. The details of the individual and the unique identifier can be stored in the database 110. In one case, an interface can be provided on the individual device 120 for an individual to interact with the disclosed system 100. The system 100 can also provide login details to the individual for secure access to the interface. The login details can include username and password, which the individual needs to provide for gaining access to the interface. The secure access may also protect any wrongful manipulation of the individual details. However, the system may also require additional verifications before updating the current address. For example, a secure code can be sent to the individual device which has to be entered to approve the change in the current mailing address. Alternatively, the system may verify any identity document or signature of the individual. The interface can be provided as application software that can be installed in the individual device 120. The application software can be developed for Android, iOS, and any other known operating platform for mobile devices. The application software can be made available through a distribution service provider, for example, Google Play operated and developed by Google, and the app store by Apple. In addition to the application software, a website-based interface can also be provided through the world-wide-web.

The system can generate a unique identifier for an individual. The unique identifier can be an alphanumeric number, for example, a twelve-digit number. The disclosed system can include a suitable algorithm to generate the unique identifier. For example, the algorithm can take the last four digits of a social security number, year of birth, and the last name of the individual to generate the unique identifier. The unique identifier can be such as easy to remember, write, or copy. Hyphens or spaces can also be added to the unique identifier to prevent any mistakes in writing or copying the unique identifier.

The disclosed system can also be connected to a service provider device 140 for retrieving the current address associated with a unique identifier. The service provider can be a courier company including the post office. The service provider can send a request that includes the unique identifier to the disclosed system for retrieving the current mailing address, which can then be used to deliver the parcel or correspondence. The service provider device can also be authenticated for communication with the disclosed system. Suitable security protocols, such as certificates and cryptographic keys can be used to authenticate the service provider device. In one case, the system can be managed by a post office (USPS in the USA) or any independent individual. The service provider device can be a workstation, desktop, thin client, laptop, smartphone, tablet computer, and like computing devices.

The individual can use the unique identifier instead of the full mailing address. for example, the individual can provide the unique identifier to the service provider, friends, relatives, eCommerce companies, and like. The unique identifier can be written on the correspondence or parcels instead of the full mailing address. In one case, the unique identifier can also be printed on contact cards both physical and digital. The unique identifier can be easily shared and stored like a mobile number. Being lesser in characters than a complete mailing address, the unique identifier takes less memory and does not require multiple fields to store the address. The unique identifier can also be represented in the form of barcodes or QR codes that can be easily scanned to retrieve the associated current mailing address.

The disclosed system can record the complete address in a detailed form having fields that make the retrieval of the current address both easier and convenient. The form having a field, such as a state can be selectively retrieved. For example, a service provider can only request the state of the individual but not the whole current mailing address. Such fields in the mailing address can be standardized, making the format of the complete mailing addresses uniform across different platforms. Uniformity prevents errors, reduces redundancy, and increases productivity. The individual can also associate the exact location coordinates with the unique identifier. Such location coordinates can also be retrieved by the service provider that can be used to navigate to the mailing address. This saves both cost and time for the service provider. Additional details, like preferred timings for the delivery, can also be recorded by the disclosed system.

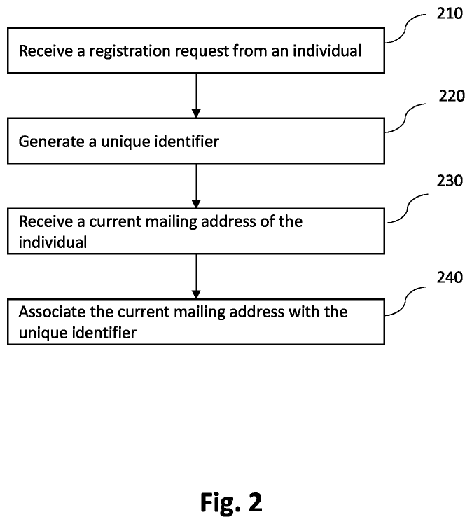

Referring to FIG. 2, which shows an exemplary embodiment of generating a unique identifier. The disclosed system can receive a registration request from an individual, at step 210. The registration request can include details of the individual, such as name, last 4 digits of social security number, contact no, and like. The disclosed system can then generate the unique identifier based on the details of the individual, at step, 220. Upon registration, the disclosed system can receive the current mailing address of the individual, at step 230. The current mailing address can then be associated with the unique identifier, at step 240.

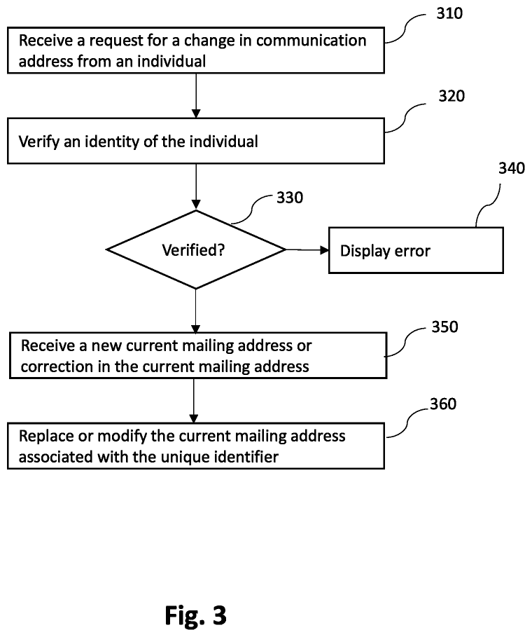

Referring to FIG. 3, which shows an exemplary embodiment of updating the current mailing address. The system can receive a request for a change in communication address, at step 310. The system can verify the identity of the individual, at step 320. A check for verification can be made at decision box 330. In case, the verification fails, an error can be displayed at step 340. In case, the verification can be done at step 330, the system can receive a new current mailing address or correction in the current mailing address, at step 350. Lastly, the current mailing address associated with the unique identifier can be replaced with the new current mailing address or modified based on the correction, at step 360.

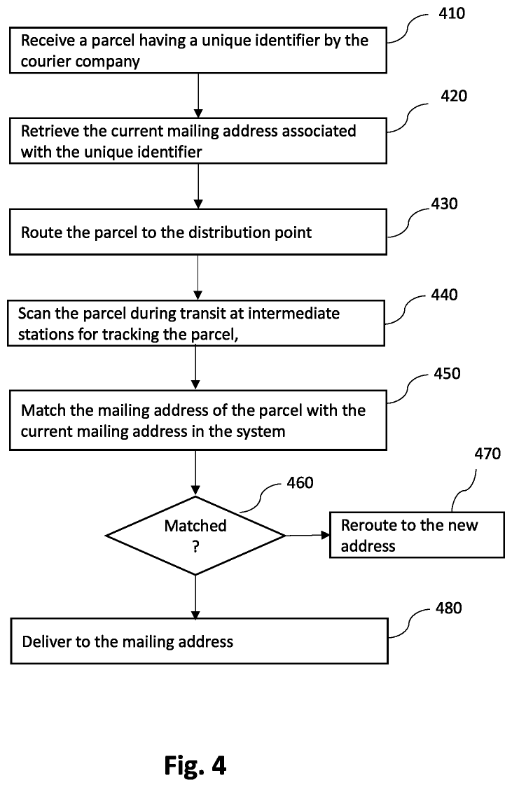

Referring to FIG. 4 which shows an exemplary embodiment of the method of delivering a parcel by a courier company. At the pickup point, the parcel having the unique identifier can be received by the courier company, at step 410. The unique identifier can be written or printed on the parcel. Alternatively, a sticker including the barcode of the unique identifier can adhere to the parcel. The courier company can retrieve the current mailing address associated with the unique identifier, at step 420. The courier company can send a query to the system, wherein the query can include the unique identifier and authentication details. The courier company can either manually note the unique identifier from the parcel and feed the same into their system or scan the unique identifier. It is a known process, wherein the courier company can apply their barcodes for tracking the parcel. Based on the retrieved current mailing address, the parcel can be routed to the distribution point, at step 430. The parcel can be scanned during transit at intermediate stations for tracking the parcel, at step 440. At one or more of such stations, the mailing address of the parcel can be matched with the current mailing address in the system, at step 450. A check can be made at step 460 if the mailing address of the parcel matches the current address in the system. In case, the match fails, the parcel can be rerouted to the new address, at step 470. In case, the match is true at step 460, the parcel can be delivered to the mailing address, at step 480.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system to provide a unique identifier for an individual, the system comprises a processor and a memory, the memory operably coupled to the processor, wherein the memory includes a set of instructions which when executed by the processor causes the processor to:
provide an interface on an individual device;
receive a registration request from the individual device through the interface, the registration request includes name and contact details of the individual; and
generate a unique identifier for the individual.

2. A system according to claim 1, wherein, the processor further:
receive a current mailing address from the individual device through the interface; and
associate the current mailing address to the unique identifier.

3. The system according to claim 2, wherein the processor further:
receive a query from a service provider device, the query comprises the unique identifier;
retrieve the current mailing address associated with the unique identifier; and
present the current mailing address to the service provider device.

4. The system according to claim 1, wherein the processor further:
receive a new current mailing address from the individual device through the interface;
verify the individual device; and
upon verification, replace the current mailing address associated with the unique identifier with the new current mailing address.

5. The system according to claim 1, wherein the contact details include last name, birth year, and last 4 digits of the social security number of the individual.

6. A computer implemented method for managing a current mailing address of an individual, the computer implemented method comprises the steps of:
providing an interface on an individual device;
receiving a registration request from the individual device through the interface, the registration request includes name and contact details of the individual;
generating and associating a unique identifier to the individual;
receiving a current mailing address from the individual device through the interface;
and associating the current mailing address to the unique identifier.

7. The computer implemented method according to claim 6, wherein the computer implemented method further comprises the steps of:
receiving a query from the service provider device, the query comprises the unique identifier;
retrieving the current mailing address associated with the unique identifier; and
presenting the current mailing address on the service provider device.

8. The computer implemented method according to claim 6, wherein the computer implemented method further comprises the steps of:
receiving a new current mailing address from the individual device through the interface;
verifying the individual device; and
upon verification, replacing the current mailing address associated with the unique identifier with the new current mailing address.

9. The computer implemented method according to claim 6, wherein the contact details include last name, birth year, and last 4 digits of the social security number of the individual.

10. A computer implemented method for delivering a parcel, the computer implemented method comprises the steps of:
receiving a registration request, by a system, from an individual device through an interface, the registration request includes contact details of the individual;
generating, by a system, a unique identifier for the individual;
receiving, by a system, a current mailing address from the individual device through the interface;
associating, by a system, the current mailing address to the unique identifier;
receiving a parcel, by a service provider device, the parcel has the unique identifier printed thereon;
receiving, by the service provider device, the unique identifier;
querying the system, by the service provider device, the unique identifier;
retrieving, by the system, the current mailing address associated with the unique identifier; and
receiving, by the service provider device, from the system, the current mailing address.

11. The computer implemented method according to claim 10, wherein the unique identifier is in the form of a barcode.
